(19) United States
(12) Patent Application Publication
(10) Pub. No.: US 2025/0360571 A1
(43) Pub. Date: Nov. 27, 2025

(54) METHOD FOR OPERATING A POWER TOOL, AND POWER TOOL

(71) Applicant: Hilti Aktiengesellschaft, Schaan (LI)

(72) Inventor: Martin SCHAEFER, Schwarzach (AT)

(21) Appl. No.: 18/867,434

(22) PCT Filed: May 26, 2023
(86) PCT No.: PCT/EP2023/064240

§ 371 Date: Nov. 19, 2024

(30) Foreign Application Priority Data
Jun. 7, 2022 (EP) 22177441.7

(51) Int. Cl. B23B 35/00; B23Q 15/08; B23Q 15/12

(52) U.S. Cl. CPC B23B 35/00; B23Q 15/08; B23Q 15/12

(57) ABSTRACT

A method for operating a power tool, wherein the power tool is initially operated with a first combination of operating parameters such that a first working progress is obtained. During operation of the power tool with the first combination of operating parameters, the first working progress can be determined and compared with a second working progress that is obtained when the power tool is operated with a second combination of operating parameters. Depending on the result of the comparison, the power tool can continue to be operated with the second combination of operating parameters or the power tool can return to operation with the first combination of operating parameters. This comparison of the working progresses can be repeated until a maximum, i.e. optimal working progress is reached or found. A power tool, wherein the power tool is preferably in the form of a drill, preferably a core drill.

The present invention relates to a method for operating a power tool, wherein the power tool is initially operated with a first combination of operating parameters such that a first working progress is obtained.

### BACKGROUND OF THE INVENTION

The prior art discloses power tools by means of which work—for example on a building site or in the DIY sector—can be carried out. Power tools may be cutting devices or cut-off devices, angle grinders or cut-off grinders, core drills, hammer drills or chisel drills, without being restricted thereto. The power tools usually comprise tools, which may be disk-shaped, rotating tools, such as cut-off disks or grinding disks, or hammering or chiselling tools. Furthermore, power tools with which substantially cylindrical drill cores can be cut out of a substrate are known, for example, in the prior art. These power tools may be drills or core drills. Core drills have, for example, core bits as tools that can be driven by the core drill to perform a rotary movement.

### SUMMARY OF THE INVENTION

The tools of the power tools that are known from the prior art are usually driven via an electric motor within the power tool. The motor rotates, with the rotation of the motor being converted into a rotation of the tool or into a hammering or chiselling movement of the tool. In addition, power tools may be equipped with a gearbox such that the power tool can be operated in different gears. Many of the power tools may be operated with different tools. For example, different grinding disks may be fastened to a grinding device in order to carry out different tasks or meet different requirements. Core drills may, for example, be operated with core bits of different diameters in order to drill holes of different sizes. The tools of the power tools may differ, for example, in terms of fineness, size, diameter or many other properties. It has previously been the case in the prior art that the power tools are usually operated with a standard set, or a plurality of standard sets, of parameters of speed and torque. The changeover from one set of parameters to another set of parameters is usually undertaken manually by the user. The user is the connecting element by said user setting different sets of parameters depending on the application. For individual applications, this situation can lead to the work to be carried out not being implemented in an optimal manner because the operating parameters, such as speed or torque, are not optimally tailored to the tool used, to the power tools present, or to the corresponding application.

It is an object of the present invention to overcome the above-described disadvantages of the prior art and of specifying a method for operating a power tool in which operating parameters, such as speed and torque, can be better adapted to different tools, to substrates to be worked, or to applications. It is also intended to provide a power tool by means of which the method can be implemented. A particular concern of the invention is to provide improved adaptation of the operating behavior of the power tool for different applications.

The present invention provides a method for operating a power tool. The method is characterized by the following method steps:
a) operating the power tool with a first combination of operating parameters, the first combination of operating parameters comprising a first speed n1 and a first torque M1,
b) determining a first working progress AF1 of the power tool when operating with the first combination of operating parameters,
c) setting a second combination of operating parameters, the second combination of operating parameters comprising a second speed n2 and a second torque M2,
d) determining a second working progress AF2 of the power tool when operating with the second combination of operating parameters,
e) comparing the first working progress AF1 with the second working progress AF2, and
continuing the operation of the power tool with the first combination of operating parameters if the first working progress AF1 is greater than the second working progress AF2, and
continuing the operation of the power tool with the second combination of operating parameters if the first working progress AF1 is less than the second working progress AF2.

With the invention, an operating method and a power tool can be provided with which the user can be supported when working with the power tool and a number of settings to be made by the user can be reduced. Tests have shown that working with the power tool is significantly easier for the user and that the use of the power tool can be improved at the same time. This in particular because the operation of the power tool can be optimally adapted to the tool of the power tool and/or to a substrate to be worked. It is preferred in the context of the invention that the power tool is a device with electronic gears, the device in particular being in the form of a core drill. The power tool can preferably be connected to an energy supply device in order to ensure that the power tool is supplied with energy. The energy supply device can preferably be a rechargeable battery or a storage battery.

If, after operation with the second set of parameters, the power tool returns to operation with the first set of parameters because the first working progress AF1 is greater than the second working progress AF2, the method can then be continued to the extent that-for example after a short period of time-the second set of parameters is set and the comparison of the working progress is repeated. If the second working progress AF2 is greater than the first working progress AF1 at this later point, the operation of the power tool can then be continued with the second set of parameters, i.e. with the second combination of operating parameters.

If the power tool is continued in this operation after operation with the second set of parameters because the first working progress AF1 is less than the second working progress AF2, the method can then be continued in that-for example after a short period of time-a third set of parameters is set. The working progress that is achieved with said third set of parameters (“third working progress AF3”) can then be compared with the second working progress. If the second working progress is greater than the third working progress, the power tool preferably returns to operation with the second set of parameters. If the second working progress is less than the third working progress, the operation of the power tool is continued with the third set of parameters. In the context of the invention, the setting of the third set of parameters is preferably also referred to as “setting a third combination of operating parameters”, the third combination of operating parameters comprising at least one third speed n3 and one third torque M3.

It is preferred in the context of the invention that the operation of the power tool is continued with the second combination of operating parameters when the first working progress AF1 is of a similar size to the second working progress AF2. In other words, work with the power tool can be continued with the second or current set of parameters if the working progresses are in a similar range.

The combinations of operating parameters preferably comprise at least one speed n and one torque M. In addition to these two operating parameters, an operating parameter combination can also comprise further additional operating parameters. It is preferred in the context of the invention that the combinations of operating parameters each comprise a set of operating parameters, with at least one speed n and one torque M being contained in each set of operating parameters. Preferably, each pair of a torque M and a speed n can represent a point in a speed-torque plot, with the set of points in said speed-torque plot forming a device characteristic. In the context of the invention, the points of the device characteristic can preferably also be referred to as operating points of the power tool, with each operating point being defined by a pair of a torque M and a speed n or by a combination of operating parameters comprising at least one torque M and one speed n.

It is preferred in the context of the invention that the device characteristic represents a relationship between the speed n and the torque M of the power tool. The device characteristic can be represented in a speed-torque plot, wherein the torque M is plotted on the x-axis and the speed n is plotted on the y-axis of the corresponding plot. It is preferred in the context of the invention that the speed n represents the speed of the motor and/or the speed of the tool of the power tool. When operating with the power tool, the user preferably moves dynamically on the device characteristic, with the current operating point being indicated by a value pair n/M of speed and torque on the device characteristic. It is preferred in the context of the invention that a device characteristic comprises a set of value pairs n/M of speed and torque. In other words, the device characteristic is formed by a set of speed/torque value pairs, with it being possible for each operating point of the power tool to be assigned a specific speed value n and a specific torque value M.

The speed can be indicated, for example, in the unit rounds per minute (rpm). The speed preferably corresponds to the rotational speed of the motor or of the motor shaft of the power tool. The term “speed” can also describe the speed of the tool of the power tool. In the context of the invention, the torque M is preferably indicated in the unit newton meter (Nm). The working progress AF of the power tool can preferably be determined in one working direction. In the context of the invention, this preferably means that working progress is oriented, for example, in a “forward” spatial direction when the power tool is held horizontally, for example to work on a wall. If the ground or a floor slab is to be worked with the power tool, the power tool can preferably be held vertically or attached to a drill stand, and therefore a working direction of the power tool in this case points in a “downward” spatial direction. A directional cross with the spatial directions is shown in the figures.

In the context of the invention, it is preferred that the second combination of operating parameters is set after a period of time ZS1. This period of time ZS1 can, for example, be stored or preset in the power tool by the manufacturer of the power tool. For this purpose, the power tool can comprise a control unit with a memory device. In the context of the invention, it is very particularly preferred that the second or further combination of operating parameters is set automatically. In the context of the invention, this preferably means that the setting no longer has to be carried out manually by a user, but rather is carried out automatically by the power tool or its control device. As a result of the preferably automatic setting of the operating parameters, the “human” source of error can advantageously be avoided and the operating parameters can be set on the basis of collected data and thus objectified. Tests have shown that the number of incorrect settings of operating parameters can thereby be significantly reduced. Since work with the power tool or with the method is focused on rapid working progress and the working progress of the power tool is optimized iteratively, particularly rapid working or drilling progress can be achieved with the invention.

When comparing the working progresses with one another, essentially two different results can be obtained in the sense of a distinction between cases. If the first working progress AF1 is greater than the second working progress AF2, the operation of the power tool is continued with the first combination of operating parameters. In the context of the invention, this preferably means that the power tool is operated at a first speed n1 and at a first torque M1 when the first working progress AF1 is greater than the second working progress AF2. In the context of the invention, the continuation of the operation of the power tool with the first combination of operating parameters can preferably also be referred to as a return to the originally or initially set operation of the power tool or a return to the originally or initially set combination of operating parameters, i.e. in particular the first combination of operating parameters. The continuation of the operation of the power tool with the first combination of operating parameters preferably means in the context of the invention that the power tool continues to be operated with the originally set first combination of the first speed n1 and the first torque M1 if the working progress with the second combination of the second speed n2 and second torque M2 decreases, i.e. AF2 is less than AF1: AF2<AF1.

If the first working progress AF1 is less than the second working progress AF2, the operation of the power tool can be continued with the second set of operating parameters, i.e. with the second combination of operating parameters. The continuation of the operation of the power tool with the second set of parameters preferably means in the context of the invention that the power tool retains its current, i.e. second, speed n2 and its current, i.e. second torque M2, if the working progress AF2 obtained in this way increases in comparison to the previous working progress AF1. Increasing working progress means that AF2 is greater than AF1: AF2>AF1.

In one configuration of the invention, it is preferred that the second torque M2 is greater than the first torque M1 (M2>M1) and the second speed n2 is less than the first speed n1 (n2<n1) and/or that the third torque M3 is greater than the second torque M2 (M3>M2) and the third speed n3 is lower than the second speed n2 (n3<n2). In this configuration of the invention, it is therefore preferred that the combination of operating parameters is shifted from smaller to larger torques M if the working progress of the power tool is intended to be increased. The increase in torques can be accompanied by a reduction or lowering of the speed n such that, in this configuration of the invention, maximum working progress or optimal operation of the power tool with comparatively high torques and low speeds is achieved.

In an alternative configuration of the invention, it is preferred that the second torque M2 is smaller than the first torque M1 (M2<M1) and the second speed n2 is greater than the first speed n1 (n2>n1) and/or that the third torque M3 is smaller than the second torque M2 (M3<M2) and the third speed n3 is greater than the second speed n2 (n3>n2). In this alternative configuration of the invention, it is therefore preferred that the combination of operating parameters is shifted from larger to smaller torques M if the working progress of the power tool is intended to be increased. The reduction in the torques can be accompanied by an increase in the speed n such that, in this configuration of the invention, maximum working progress or optimal operation of the power tool is achieved with comparatively low torques and high speeds.

This configuration of the invention can be used, for example, when the substrate changes. For example, if the power tool or its tool encounters rebar or reinforcing bar in concrete, it may be desirable for the power tool to be able to provide a higher torque M in order to cut through the rebar. Pure concrete is preferably worked with a high speed n of the core bit and a low torque M. If the power tool detects a reinforcement hit, it is preferred in the context of the invention to switch from a current set of parameters to another set of parameters in which the torque M is higher and the speeds n are lower than in the current set of parameters.

In addition, as the depth of a hole increases, it may be desirable to operate the power tool with a higher torque M since higher forces may be required due to the wall friction to achieve drilling progress. It is preferred in the context of the invention that a parameter set with higher speeds n and lower torques M is used for small drilling depths, while the power tool is operated with lower speeds n and higher torques M for deeper holes.

It is preferred in the context of the invention that the power tool is in the form of a drill, preferably a core drill, and therefore the working progress is drilling progress and/or a tool of the power tool is a core bit. In this configuration, the invention relates to a method for operating a drill, in particular a core drill, wherein the method is characterized by the following method steps:
a) operating the drill with a first combination of operating parameters, the first combination of operating parameters comprising a first speed n1 and a first torque M1,
b) determining a first drilling progress AF1 of the power tool when operating with the first combination of operating parameters,
c) setting a second combination of operating parameters, the second combination of operating parameters comprising a second speed n2 and a second torque M2,
d) determining a second drilling progress AF2 of the power tool when operating with the second combination of operating parameters,
e) comparing the first drilling progress AF1 with the second drilling progress AF2, and
continuing the operation of the power tool with the first combination of operating parameters if the first drilling progress AF1 is greater than the second drilling progress AF2, and
continuing the operation of the power tool with the second combination of operating parameters if the first drilling progress AF1 is less than the second drilling progress AF2.

Method step e), i.e. comparing the working progresses with one another, can be repeated until a combination of operating parameters is found at which the working progress of the power tool is at its maximum. It can be preferred in the context of the invention that this maximum or optimal working or drilling progress is different depending on the material of the substrate to be worked. For example, unreinforced concrete can be worked with a combination of a comparatively high speed and a comparatively low torque, while reinforced concrete, particularly in the region of the reinforcement, is ideally worked with an increased torque, with a higher torque preferably being associated with a lower speed.

It is preferred in the context of the invention that the operation of the drill is continued with the second combination of operating parameters when the first drilling progress AF1 is of a similar size to the second drilling progress AF2. In other words, work with the power tool can be continued with the second or current set of parameters if the drilling progresses are in a similar range.

In the context of the invention, it is very particularly preferred that method step e: “comparing the working progresses” is repeated, with the following proviso:
comparing the previous working progress AF(i-1) with the current working progress AF(i), and
continuing the operation of the power tool with the (i-1)-th combination of operating parameters if the (i-1)-th working progress is greater than the i-th working progress, and
continuing the operation of the power tool with the (i)-th combination of operating parameters if the (i-1)-th working progress is less than the i-th working progress.

In the context of the invention, the continuation of the operation of the power tool with the (i-1)-th combination of operating parameters preferably corresponds to a return to the originally set operation of the power tool or a return to the originally set combination of operating parameters, i.e. in particular the (i-1)-th combination of operating parameters.

It is preferred in the context of the invention that the operation of the power tool is continued with the i-th combination of operating parameters if the (i-1)-th working progress AF1 is of a similar size to the i-th working progress AF2. In other words, work with the power tool can be continued with the i-th set of parameters if the working progresses are in a similar range. By repeating method step e in this way: “comparing the working progresses”, an optimal combination of operating parameters, in particular torque and speed, at which the working progress of the power tool or drill is at maximum, can advantageously be found. Owing to the preferably continued iteration of the working progress comparisons throughout the entire operation of the power tool, operation of the power tool in a manner optimized to the current application requirements at all times can advantageously be guaranteed. If, for example, the substrate to be worked changes, the power tool can use the method to set different sets or combinations of operating parameters, such as torque and speed, and by comparing the respective working progresses, determine which combination of operating parameters should be used to continue working. The power tool preferably returns to an earlier set of operating parameters as the working progress decreases, while the power tool sets a new set of operating parameters as the working progress increases.

In a further aspect, the invention relates to a power tool for carrying out the method for operating a power tool. The terms, definitions and technical advantages introduced for the operating method preferably apply in an analogous manner to the power tool. The power tool is characterized in that the power tool is in the form of a drill, preferably a core drill, and therefore the working progress is drilling progress and/or a tool of the power tool is a core bit. The power tool can preferably detect sensors for determining the working progress. Said sensors can preferably be internal and/or external sensors. In the context of the invention, internal sensors are installed in the power tool or are integrated in the power tool. Said sensors may be, for example, distance sensors or speed sensors. The distance sensors can preferably involve physical measurement principles or types of radiation, such as laser, light, i.e. electromagnetic radiation with visible wavelengths, or ultrasound. The external sensors can preferably be sensors that can be attached or fastened to the power tool or to accessory devices for the power tool, such as a drill stand, feed device or the like. External sensors can be connected to the power tool or can communicate with the power tool with a cable or wirelessly, for example. The external sensors can also be distance sensors, speed sensors, and travel distance measurement sensors, without being limited thereto. The sensors are preferably each configured to communicate or to exchange data with the power tool in the sense that measured values can be transmitted from the sensors to the power tool. This can preferably involve raw data or data that has already been processed using information technology. The exchange of data between the power tool and the sensors is preferably undertaken wirelessly and/or with a cable.

It can also be preferred in the context of the invention that the power tool is connectable to an accessory device, with the accessory device being configured to determine the working progress of the power tool. The accessory device can preferably be a feed device for generating a feed for the power tool. For example, the feed device can be an automatic feed device with which a feed for the power tool can be generated and transmitted to the power tool. In one exemplary embodiment of the invention, the feed device can comprise a speed sensor which is configured to determine a speed of a motor or rotor of the feed device. The feed device or the speed sensor can also be configured to use the determined speed to determine a drilling feed per rotor revolution and to transmit same to the power tool.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form sensible further combinations.

Identical and functionally identical components are denoted by the same reference signs in the figures. In the drawings:

FIG. 1 shows a view of an exemplary embodiment of a power tool

FIG. 2 shows a view of an exemplary embodiment of a power tool which is attached to a drill stand and is connected to an accessory device.

### DETAILED DESCRIPTION

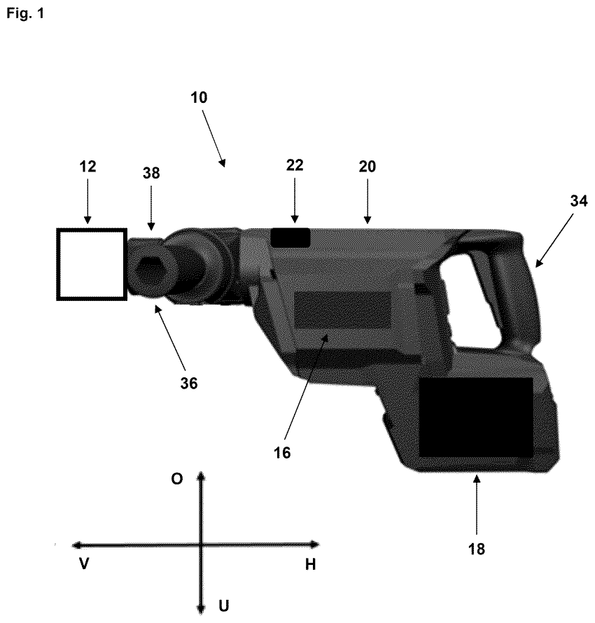

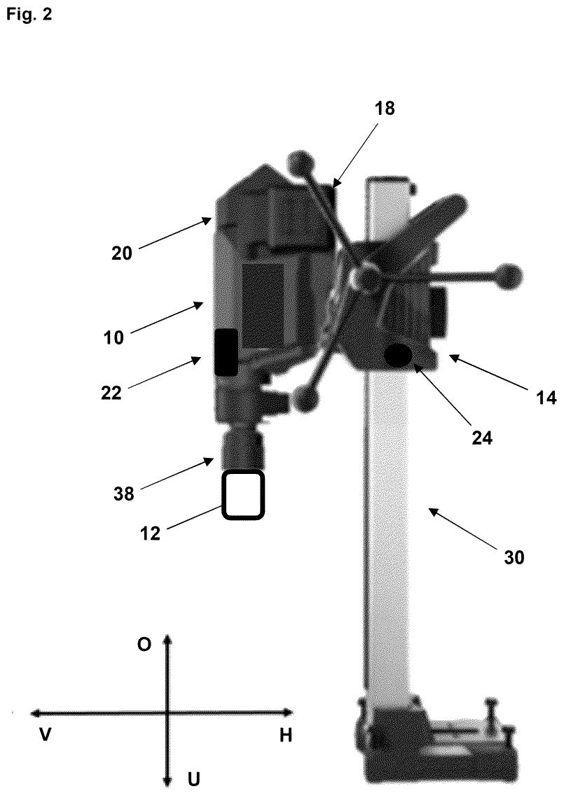

FIG. 1 shows an exemplary embodiment of a power tool 10. The power tool 10 can be in the form of a drill, in particular a core drill, and have a core bit as the tool 12 (illustrated schematically). The tool 12 can be fastened to the power tool 10 by means of a tool fitting 38. The tool 12 of the power tool 10 is preferably configured to perform a rotational movement, it being possible for the tool 12 to be able to be driven by a motor 16 of the power tool 10 to perform the rotational movement. The power tool 10 can be supplied with energy via an energy supply device 18 which can be in the form of a rechargeable battery, for example. The power tool 10 can have various handles 34, 36, with the power tool 10, which is shown as an exemplary embodiment of the invention in FIG. 1, having a rear handle 34 and a front handle 36. The front handle 36 can, for example, be rotatable such that the front handle 36 can protrude to the side, for example, or can extend “downward” in a spatial direction. The “top O”, “bottom U”, “front V” and “rear H” spatial directions are indicated in the figures by directional crosses. If the power tool 10—as in FIG. 1—is held horizontally, for example to drill a hole in a wall, the working direction preferably corresponds to the “forward V” spatial direction. If the power tool 10—as illustrated in FIG. 2—is arranged on a drill stand 30 and is working on a floor surface or a substrate, the working direction of the power tool 10 preferably corresponds to the “downward U” spatial direction.

The power tool 10 can comprise a housing 20 which, for example, comprises the motor 16 and/or the energy supply device 18 of the power tool 10. The housing 20 can be designed in one or more parts, with the housing 20 shown in FIG. 1 being designed in two parts in the sense that it comprises a motor housing and a battery housing, the motor housing being configured to receive the motor 16 of the power tool 10, and the battery housing being configured to receive the energy supply device 18 of the power tool 10.

The power tool 10 can have at least one sensor 22, which is configured to detect working progress of the power tool 10. The at least one sensor 22 can be arranged at many different locations and positions of the power tool 10.

FIG. 2 shows an exemplary embodiment of a power tool 10 which is attached to a drill stand 30 and is connected to an accessory device 14. The accessory device 14 can be, for example, a feed device which is configured to generate a feed for the power tool 10. The feed device 14 illustrated in FIG. 2 is a manual feed device 14 which comprises a handwheel. However, it may also be preferred in the context of the invention for the feed device 14 to be an automatic feed device 14. The accessory device 14 is preferably capable of detecting working progress of the power tool 10. The accessory device 14 can also comprise sensors 24 for this purpose. The position of the sensor 24 that is illustrated in FIG. 2 for detecting working progress of the power tool 10 should be understood as being by way of an example. Of course, the sensor 24 may also be arranged at other points of the accessory device 14, which is preferably in the form of a feed device.

### LIST OF REFERENCE SIGNS

10 Power tool
12 Tool of the power tool
14 Accessory device of the power tool
16 Motor of the power tool
18 Energy supply device of the power tool
20 Housing of the power tool
22 Sensor on the power tool
24 Sensor on the accessory device
30 Drill stand
34 Rear handle
36 Front handle
38 Tool fitting
V “Forward” spatial direction, front side
H “Rearward” spatial direction, rear side
U “Downward” spatial direction, underside
O “Upward” spatial direction, top side

What is claimed is:

1-11. (canceled)

12. A method for operating a power tool, the method comprising the following steps:
a) operating the power tool with a first combination of operating parameters, the first combination of operating parameters comprising a first speed n1 and a first torque M1,
b) determining a first working progress AF1 of the power tool when operating with the first combination of operating parameters,
c) setting a second combination of operating parameters, the second combination of operating parameters comprising a second speed n2 and a second torque M2,
d) determining a second working progress AF2 of the power tool when operating with the second combination of operating parameters,
e) comparing the first working progress AF1 with the second working progress AF2, and
continuing the operation of the power tool with the first combination of operating parameters if the first working progress AF1 is greater than the second working progress AF2, and
continuing the operation of the power tool with the second combination of operating parameters if the first working progress AF1 is less than the second working progress AF2.

13. The method as recited in claim 12 wherein the second torque M2 is greater than the first torque M1 (M2>M1) and the second speed n2 is lower than the first speed n1 (n2<n1).

14. The method as recited in claim 12 wherein the second torque M2 is smaller than the first torque M1 (M2<M1) and the second speed n2 is greater than the first speed n1 (n2>n1).

15. The method as recited in claim 12 wherein the power tool is a drill.

16. The method as recited in claim 15 wherein the drill is a core drill.

17. The method as recited in claim 15 wherein a tool of the power tool is a core bit.

18. The method as recited in claim 12 wherein the working progress is a drilling progress.

19. The method as recited in claim 12 wherein the method step e is repeated until a combination of operating parameters is found in which the working progress of the power tool is at maximum.

20. The method as recited in claim 12 wherein the method step e is repeated, with the following proviso:
comparing the previous working progress AF(i-1) with the current working progress AF(i), and
continuing the operation of the power tool (10) with the (i-1)-th combination of operating parameters if the (i-1)-th working progress is greater than the i-th working progress, and
continuing the operation of the power tool (10) with the (i)-th combination of operating parameters if the (i-1)-th working progress is less than the i-th working progress.

20. A power tool carrying out the method as recited in claim 12.

21. The power tool as recited in claim 20 wherein the power tool is a drill.

22. The power tool as recited in claim 20 wherein the drill is a core drill.

23. The power tool as recited in claim 20 further comprising a core bit.

24. The power tool as recited in claim 20 wherein the working progress is a drilling progress.

25. The power tool as recited in claim 20 wherein the power tool detects sensors for determining the working progress.

26. The power tool as recited in claim 20 wherein the power tool is connectable to an accessory configured to determine the working progress of the power tool.

27. The power tool as recited in claim 20 wherein the accessory device is a feed device for generating a feed for the power tool.
